(19) United States
(12) Patent Application Publication
(10) Pub. No.: US 2017/0314740 A1
(43) Pub. Date: Nov. 2, 2017

(54) LIGHTING DEVICE

(71) Applicant: PHILIPS LIGHTING HOLDING B.V., EINDHOVEN (NL)

(72) Inventors: Antonius Adrianus Maria MARINUS, EINDHOVEN (NL); Hendrik Jan EGGINK, EINDHOVEN (NL); Andreas Martinus Theorodus Paulus VAN DER PUTTEN, EINDHOVEN (NL)

(21) Appl. No.: 15/521,309

(22) PCT Filed: Nov. 12, 2015
(86) PCT No.: PCT/EP2015/076394

§ 371 Date: Apr. 24, 2017

(30) Foreign Application Priority Data
Nov. 17, 2014 (EP) 14193465.3

(51) Int. Cl. F21K 9/237; F21V 3/04; F21V 29/85; F21K 9/232; F21K 9/62; F21V 17/10; F21V 3/02; F21Y 2115/10

(52) U.S. Cl. CPC F21K 9/237; F21V 17/101; F21V 3/0418; F21V 3/02; F21V 29/86; F21K 9/232; F21K 9/62; F21Y 2115/10

(57) ABSTRACT

The present invention relates to a lighting device (1, 2, 5, 6) comprising a hollow and translucent envelope (12, 22, 52) connected to a base (13, 23, 53); a light mixing element (10, 20, 30, 50, 60) arranged within the envelope (12, 22, 52); and at least one light emitting diode (11, 21, 31, 51) arranged within the envelope (12, 22, 52), arranged to emit light into the light mixing element (10, 20, 30, 50, 60) and arranged in thermal contact with the light mixing element (10, 20, 30, 50, 60). The light mixing element (10, 20, 30, 50, 60) comprises a thermally conductive and translucent ceramic material. The light emitted from the light emitting diode (11, 21, 31, 51) is mixed within the light mixing element (10, 20, 30, 50, 60), distributed from the light mixing element (10, 20, 30, 50, 60) through the thermally conductive and translucent ceramic material, and transmitted through the translucent envelope (12, 22, 52). The present invention also relates to a luminaire comprising such a lighting device (1, 2, 5, 6).

### FIELD OF THE INVENTION

The present invention relates to a lighting device comprising an envelope, a base connected thereto and at least one light emitting diode arranged within the envelope.

### BACKGROUND OF THE INVENTION

A lighting device construction which has been known for decades is the incandescent light bulb. It includes a glass bulb, forming an envelope, attached to a base. A filament is provided within the glass bulb and connected to the base. The filament glows when a current is provided through it and thus functions as a light source. Since this lighting device is well-known there exist lighting devices which mimics the light effect of the incandescent lighting device, but comprise a more modern light source, such as light emitting diodes, in order to decrease power consumption and to reduce heat. Such lighting devices are getting increasingly popular. Market studies show that customers appreciate these types of lamps. Transparent lighting devices which have a bulb shape are by many consumers regarded as aesthetically appealing.

A lighting device in the form of a light bulb with light emitting diodes may comprise a translucent envelope which is connected to a base. The base is provided for housing connection means between an external power supply and a light emitting diode arranged within the lighting device. The base is also provided for attaching the lighting device to for example a lamp base.

As an example, U.S. Pat. No. 8,692,449 discloses a lighting device simulating the effect of an incandescent light bulb. Visible light is provided by one or more light emitting diodes and passed through a light diffuser. The light emitting diodes and the diffuser are mounted inside a transparent or light-transmissive envelope. The diffuser tube may be made in an optically clear material such as acrylic.

US 2012/126260 discloses a lighting device with the LEDs mounted in a wavelength conversion tube. In this device the heat is transferred to the ambient via the stand-offs or via a heat sink.

In WO2013/014821 a lighting device is disclosed with a light source on a mounting board, positioned in a helium gas filled bulb. Main topic of this application is on the placement of an antenna in the bulb.

Even though light emitting diodes are more heat-efficient than conventional filaments, there still exists a need for reducing the production of heat and to improve the dissipation of heat from the lighting device. It may also be desirable to mimic the function of an incandescent lamp in order to provide a recognizable lighting device.

### SUMMARY OF THE INVENTION

An object of the present invention is to provide a lighting device which comprises one or more light emitting diodes as light source and which has an improved thermal and/or optical behavior with respect to known lighting devices with the same type of light source. Another object of the present invention is to provide a lighting device with light emitting diodes wherein the lighting device provides omnidirectional light, i.e. light that is provided in all directions. Omnidirectional light is opposite to directional light which is a typical characteristic for a light emitting diode.

According to a first aspect of the invention it is therefore provided a lighting device comprising a hollow and translucent envelope connected to a base; a light mixing element arranged within the envelope; and at least one light emitting diode arranged within the envelope, arranged to emit light into the light mixing element and arranged in thermal contact with the light mixing element. The light mixing element comprises a thermally conductive and translucent ceramic material. The light emitted from the light emitting diode is mixed within the light mixing element, distributed from the light mixing element through the thermally conductive and translucent ceramic material, and transmitted through the translucent envelope.

The abbreviation LED for light emitting diode, and LEDs for light emitting diodes, will be used throughout the application.

The invention is based upon the identification of a number of characteristics which would improve a lighting device with LEDs as light sources. The identified characteristics have lead to the use of a light mixing element comprising a thermally conductive and translucent ceramic material into which light from one or more LEDs is emitted.

Any number of LEDs, to a realistic extent, can be arranged to emit light into the light mixing element without the need for reconstruction of the light mixing element. Thus the construction of the light mixing element is independent from the number of LEDs.

By that the light emitted from the LEDs are mixed in and distributed from the light mixing element, characteristics such as color temperature and light distribution can be altered by adapting the configuration of the light mixing element. Thus, the lighting device may be configured so as to mimic an incandescent lamp in view of e.g. color temperature and light distribution without altering the LEDs.

Spottiness and glare may be counteracted by that the light mixing element distributes the light emitted from the LEDs from a larger surface when compared to the light emitting surfaces of the LEDs. Moreover, by use of a larger surface, the thermal resistance is decreased which improves the efficiency of heat dissipation. The thermal resistance is directly related to the heat dissipation surface area that is exposed to the ambient gas, in this case the internal gas with which the envelope is filled with. In order to improve the heat dissipation efficiency of the lighting device, it has been realized that the use of a thermally conductive and translucent ceramic material in the light mixing element is advantageous. Examples of conductive and translucent ceramic materials are poly crystalline alumina (PCA), Spinel and magnesia (magnesium oxide, MgO) materials.

Accordingly, the light mixing element functions as both a light spreader and a heat spreader.

According to one embodiment, the translucent ceramic material is poly crystalline alumina (PCA). The abbreviation PCA will be used throughout the application. It has been realized that the use of a PCA material is particularly advantageous. PCA has been identified to have good thermal properties, electrical isolation properties, mechanical properties and optical properties which are suitable for use in the light mixing element. The light mixing element may be made of PCA in full or comprise one or more portions made of PCA. PCA may be formed as a light diffusing material, i.e. translucent but non-transparent, which contributes to spreading the light and thus reducing spottiness of the lighting device.

The light mixing element may have a cylindrical shape. This may be preferred since the shape mimics the shape of a filament in a conventional incandescent lamp well. The shape is well-known and may therefore be appealing for a consumer.

The light mixing element may be hollow. LEDs may thereby easily be inserted into the light mixing element during assembly of the lighting device. Since the LEDs can be arranged within the light mixing element, the yellow phosphor of the LEDs can be hidden such that it is not visible from the outside of the lighting device.

An LED may be arranged at an end of the light mixing element which faces the envelope. It has been realized that an improvement in heat conduction over conventional incandescent lamps, and also over known LED lighting devices mimicking incandescent lamps, can be reached by placing the LED close to the envelope. The envelope may be in the form of a glass bulb. Heat produced by the LED is thereby transported to the outside of the lighting device by both natural convection and by direct heat conduction to the glass bulb through the internal gas of the glass bulb. The light mixing element may be oriented such that an LED may be arranged in each end of the light mixing element which faces the envelope.

In one embodiment, the light mixing element comprises a cylindrical tube. A cylindrical tube is an extruded component which is inexpensive to manufacture. The light mixing element may comprise an end cap arranged at each end of the cylindrical tube. An LED may be arranged within the cylindrical tube at each end cap. The main surfaces of the end caps may be flat which facilitates the attachment of an LED, in particular when the LED comprises a substrate which is typically shaped flat.

If a distance between the light mixing element and the envelope is sufficiently small, the direct heat conduction may transfer heat more efficiently than the natural convection. It has been realized that this is achieved when the distance is comparable or smaller than the summed effective thermal boundary layers at the light mixing element side and at the envelope side.

In one embodiment, the envelope may be filled with a gas comprising at least 70% helium by volume.

The distance between the light mixing element and the envelope may be equal to or less than 10 mm. This embodiment provides an advantage of increased heat conduction efficiency.

The lighting device may further comprise a support member connecting the at least one LED to the base. The support member may be arranged to support the light mixing element. The support member may be formed by conductive wires which conductively connect each of the LEDs in the lighting device to the base. The support member thus provides both the function of supporting the light mixing element and the function of providing a conductive connection between the LEDs and the base.

The support member may comprise one or more spring elements. The spring elements may be advantageous in that they can absorb vibrations of the light mixing chamber so as to stabilize the light emission path.

The support member may be coated with an electrically isolating material. Thus, the conductive wires are safe to touch if the envelope would break. The light mixing element is difficult to break since it is made in a ceramic material, preferably a PCA material.

The envelope may be filled with a low weight gas or a mixture comprising a low weight gas arranged in thermal contact with the at least one LED, the light mixing element and the envelope. Such gases improve the thermal properties and thus enhance the direct heat conduction from the light mixing element to the envelope. Examples of a low weight gases are hydrogen and helium.

According to a second aspect of the invention, a luminaire comprising a lighting device according to any embodiment disclosed above is provided. The functions and advantageous disclosed in connection to the first aspect also applies to the second aspect. In order to avoid undue repetition, reference is made to the above disclosure.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing exemplary embodiments of the invention. As illustrated in the figures, the sizes of layers and regions are exaggerated for illustrative purposes and, thus, are provided to illustrate the general structures of embodiments of the present invention.

FIG. 1 illustrates a lighting device according to a first embodiment.

FIG. 2 illustrates a lighting device according to a second embodiment.

FIG. 3 illustrates an embodiment of a light mixing chamber.

FIG. 4 illustrates how heat is transported by natural convection within a prior art lighting device.

FIG. 5a illustrates a lighting device according to a third embodiment.

FIG. 5b illustrates how heat is transported within the lighting device in FIG. 5a.

FIG. 6 illustrates a lighting device according to a fourth embodiment.

FIGS. 7a and 7b illustrate embodiments of lighting devices according to the present invention.

### DESCRIPTION OF EXAMPLE EMBODIMENTS OF THE PRESENT INVENTION

In the following description, the present invention is described with reference to a lighting device comprising an envelope in the form of a light bulb. It should, however, be noted that this by no means limits the scope of the invention, which is equally applicable to other applications where the lighting device comprises an envelope of another shape.

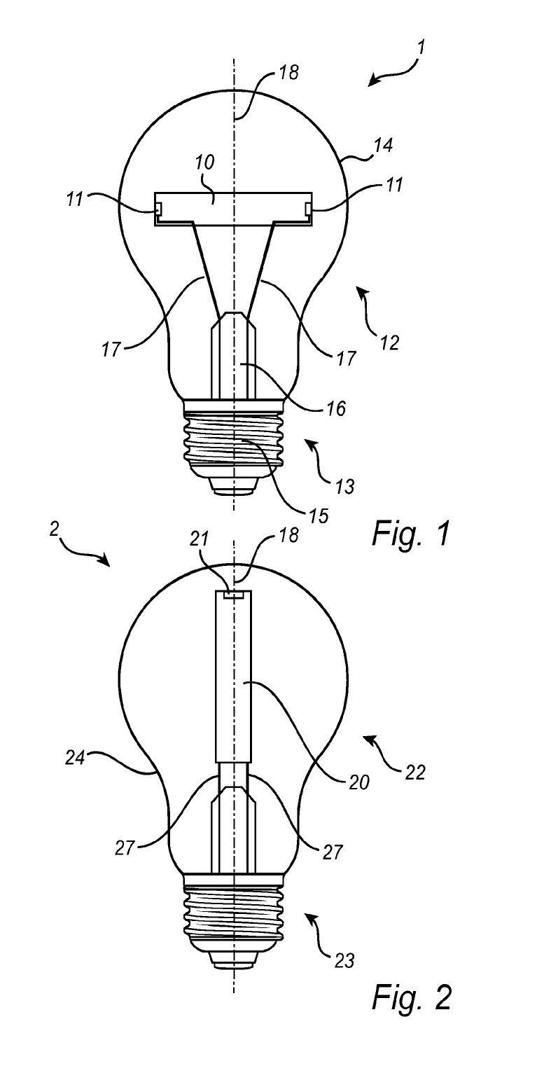

A lighting device 1 according to a first embodiment is illustrated in a view from the side in FIG. 1. The lighting device 1 comprises a light mixing element 10. The light mixing element 10 has a cylindrical shape. The light mixing element 10 may be formed by a solid or hollow body. Within the light mixing element 10, two LEDs 11 are arranged. Each LED 11 is arranged such that it emits light into the light mixing element 10. Each LED 11 is arranged in thermal connection with the light mixing element 10. It is appreciated that the number of LEDs 11 is at least one and may vary in number between different embodiments.

The light mixing element 10 with the LEDs 11 are arranged within a hollow and translucent envelope 12. The envelope 12 is in this embodiment formed by a bulb 14. The bulb 14 may be made in a clear or semi-transparent material. Non-limiting examples of material are glass and plastics.

The wording translucent is to be understood as permitting the passage of light. Hence, translucent is to be understood as “permitting the passage of light” and a translucent material may either be clear, i.e. transparent, or transmitting and diffusing light so that objects beyond the light guide cannot be seen clearly. Transparent is to be understood as “able to be seen through”.

The bulb 14 is connected to a base 13. The base 13 comprises a connection member 15 for attaching the lighting device 1 to e.g. a lamp base and for providing a conductive connection between an external power supply, provided e.g. within the lamp base, and inner conductors of the lighting device 1.

A body 16 is arranged within the bulb 14 and is connected to the connection member 15. The body 16 is a stem tube which can be made of a glass material. When assembling the lighting device 1, the envelope is sealed, after providing the intended components within the envelope 12, by providing the body 16 and attaching it to the envelope 12 by means of for example melting.

A support member in the form of a pair of conductive wires 17 are arranged within the glass bulb 14. The conductive wires 17 conductively connect each of the LEDs 11 to the connection member 15 such that the LEDs 11 may be powered when the lighting device 1 is attached to an external power supply through the base 13. The contact between the conductive wires 17 and the LEDs 11 can be an Au/Sn solder joint. The pair of conductive wires 17 is not in optical contact with the light mixing element 10 in order to prevent optical failures.

The conductive wires 17 are also arranged to support the light mixing element 10. The supporting function could for example be realized by that the conductive wires 17 are made of a stiff material. Alternative embodiments of the support element will be disclosed later in connection to FIG. 6.

The light mixing element 10 forms an elongated body which extends in a direction perpendicular to an elongation axis 18 of the lighting device 1. In this first embodiment, it can also be said that the light mixing element 10 is oriented horizontally when the lighting device 1 is arranged in an upright position. By this shape and orientation of the light mixing element 10, a filament of an incandescent lamp is mimicked with respect to its appearance.

During the assembly of the lighting device 1, the light mixing element 10 may be oriented along a direction parallel to the elongation axis 18 of the lighting device 1 while inserting it into the bulb 14. The conductive wires 17 may be used to reorient the light mixing element 10 into the final position where it extends in a direction perpendicular to the elongation axis 18.

The function of the inventive lighting device, exemplified by the lighting device 1, will now be disclosed. Light emitted from each of the LEDs 11 is mixed within the light mixing element 10, distributed from the outer surface of light mixing element 10 through the mixture of gases within the bulb 14, and thereafter transmitted through the translucent bulb 14. The light mixing element 10 thus mimics a filament in an incandescent lighting device. The light mixing element 10 may be arranged to distribute light from a portion from its outer surface.

The invention is based upon the identification of a number of characteristics which would improve a lighting device comprising LEDs as light sources.

Firstly, it is desired that the construction of the light mixing element should be independent from the number of LEDs and type of LEDs.

Secondly, it is desired that the lighting device have the same color temperature behavior as an incandescent lamp. The lighting device should also provide a natural dim characteristic and also have a nice light distribution.

Thirdly, the lighting device would provide a nice appearance if the yellow phosphor of the LEDs is hidden.

Finally, spottiness and glare may be at least counteracted by that the emitted light is spread over a larger surface instead of being provided in a directional manner.

The identified characteristics above have lead to the use of a light mixing element 10 into which light from one or more LEDs 11 is emitted.

Any number of LEDs 11, to a realistic extent, can be arranged to emit light into the light mixing element 10 without the need for reconstruction of the light mixing element 10. Thus the construction of the light mixing element 10 is independent from the number of LEDs 11.

By that the light emitted from the LEDs 11 are mixed in and distributed from the light mixing element 10, characteristics such as color temperature and light distribution can be altered by adapting the configuration of the light mixing element 10. Thus, the lighting device 1 may be configured so as to mimic an incandescent lamp in view of e.g. color temperature and light distribution without altering the LEDs 11.

Since the LEDs 11 can be arranged within the light mixing element 10, the yellow phosphor of the LEDs 11 can be hidden such that it is not visible from the outside of the lighting device.

Spottiness and glare is counteracted by that the light mixing element 10 distributes the light emitted from the LEDs 11 from a larger surface when compared to the light emitting surfaces of the LEDs 11. Moreover, by use of a larger surface, the thermal resistance is decreased which improves the efficiency of dissipation of heat generated by the LEDs 11. The thermal resistance is directly related to the heat dissipation surface area that is exposed to the ambient gas, in this case the gas with which the bulb 14 is filled with.

In order to improve the heat dissipation efficiency of the lighting device 1, it has been realized that the use of a thermally conductive and translucent ceramic material in the light mixing element 10 is advantageous. It has been realized that the use of a poly crystalline alumina (PCA) material is particularly advantageous.

PCA has been identified to have good thermal properties, electrical isolation properties, mechanical properties and optical properties which are suitable for use in the light mixing element 10. The light mixing element 10 may be made of PCA in full or comprise one or more portions made of PCA.

A lighting device 2 according to a second embodiment is illustrated in FIG. 2. The lighting device 2 comprises a base 23 and an envelope 22. The envelope 22 is in the form of a bulb 24. The lighting device 2 further comprises a light mixing element 20. An LED 21 is arranged to emit light into the light mixing element 20. The LED 21 is conductively connected to the base 23 through conductive wires 27. The base 23 is in turn arranged to be connected to an external power supply in order to power the LED 21.

The components of FIG. 2 can have the same structure and function as the corresponding ones in the first embodiment. In this second embodiment, however, the light mixing element 20 forms an elongated body which is arranged to extend parallel to an elongation axis 18 of the lighting device 2. By this orientation, the mounting of the lighting device 2 may be facilitated. The light mixing element 20 may be inserted into the bulb 24 along the elongation axis 28 and arranged in its final position without the need for reorientation of the light mixing element 20.

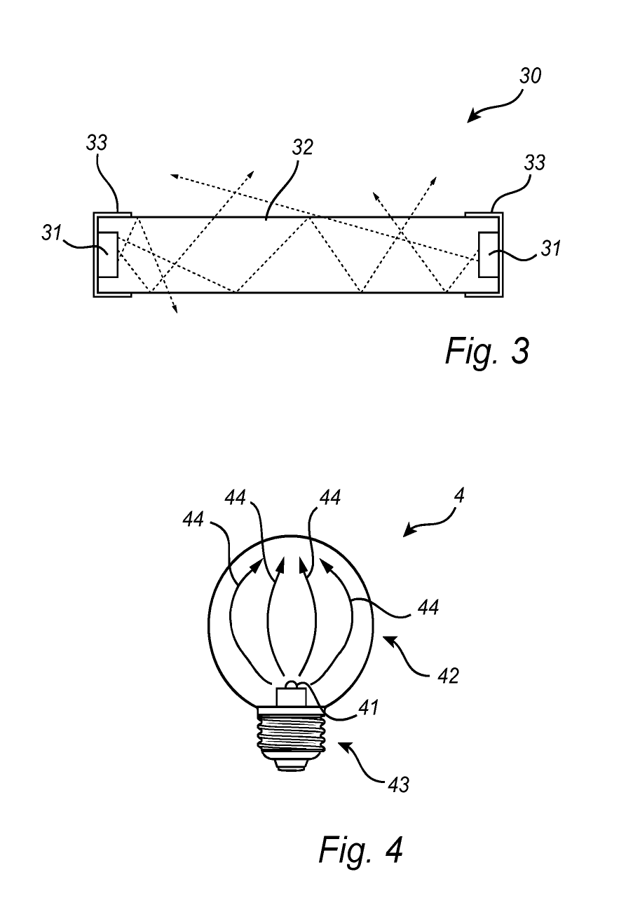

An embodiment of a light mixing element 30 is illustrated in FIG. 3. The light mixing element 30 is an example of how the light mixing elements 10, 20 of the first and second embodiments may be formed.

The light mixing element 30 has a cylindrical shape. The light mixing element 30 comprises a cylindrical tube 32 provided with open ends. The cylindrical tube 32 is an extruded component which is inexpensive to manufacture.

The light mixing element 30 further comprises an end cap 33 arranged at each open end of the cylindrical tube 32. The end caps 33 may be glued to the cylindrical tube 32 with thermally conductive filler, preferably silicone based, in order to withstand high temperatures. The cylindrical tube 32 and the end caps 33 together form a light mixing chamber.

A LED 31 is arranged within the cylindrical tube 32 at each end cap 33. Each LED 31 is attached to the respective end caps 33. Each LED 31 may comprise a light emitting diode unit arranged on a substrate such as a printed circuit board (PCB). In this embodiment, the main surface of the end cap 33, i.e. the surface covering the open end of the cylindrical tube 32, is flat which facilitates the attachment of the LED 31, in particular when the LED 31 comprises a substrate which is typically shaped flat.

Each LED 31 is arranged to emit light inwards into the cylindrical tube 32. The emitted light is mixed within the cylindrical tube 32 and thereafter distributed from the cylindrical tube 32 by transmission through the tube walls. The cylindrical tube 32 may comprise one or more light exit portions (not illustrated) through which light inside the cylindrical tube 32 is allowed to be transmitted to outside of the cylindrical tube 32. The light exit portion comprises a thermally conductive and translucent ceramic material, preferably PCA. The whole of the cylindrical tube 32 may be made of the thermally conductive and translucent ceramic material.

The light mixing element 30 formed by the cylindrical tube 32 and the end caps 33 provides the possibility of natural dimming. This means that the lighting device in which the light mixing element 30 with LEDs 31 are arranged can be arranged to have the same color temperature behavior as an incandescent lamp. Light of different color temperatures can easily be mixed, e.g. white light and amber, within the light mixing element 30.

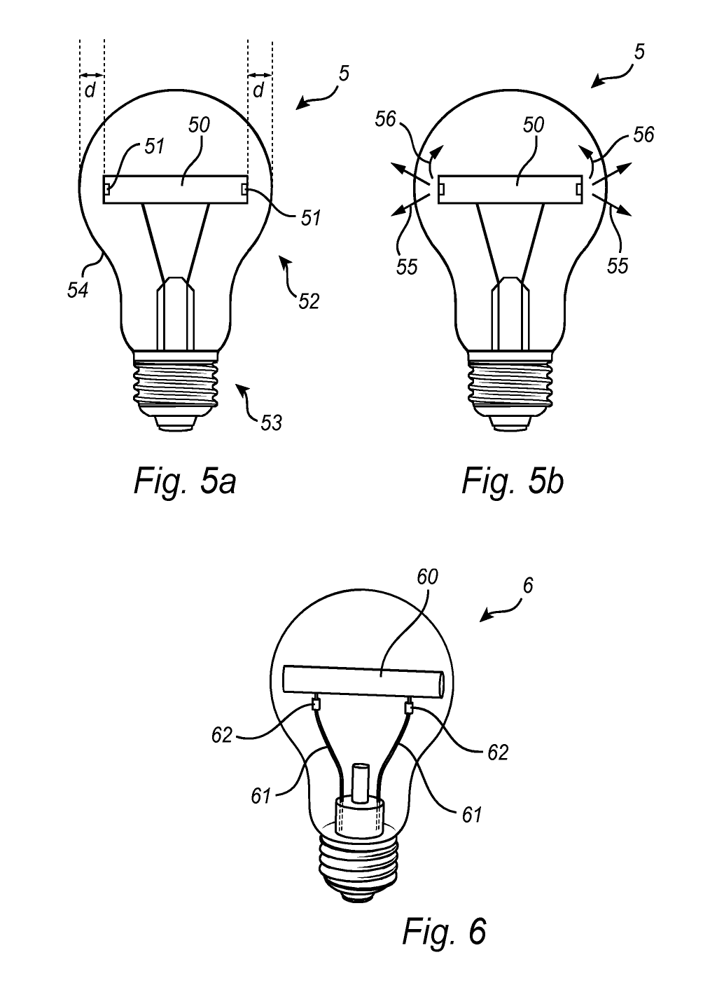

A lighting device 5 according to a third embodiment will now be disclosed with reference to FIG. 4 and FIGS. 5a and 5b.

Starting in FIG. 4, a conventional lighting device 4 is illustrated. The lighting device 4 comprises an envelope 42 and a base 43. A light source in the form of a LED 41 is arranged within the envelope 42 to provide light. The LED 41 may be attached to e.g. a heat sink. The lighting device 4 may comprise further LEDs. The LED 41 may be arranged on a substrate.

The LED 41 produces heat when emitting light. The heat is transported by free convection, indicated by 44, to the envelope 42, being e.g. a glass bulb. The lighting device 4 in FIG. 4 is thus cooled by free convection and optionally also by the use of a heat sink.

Now turning to FIGS. 5a and 5b, the lighting device 5 according to the third embodiment is illustrated. The lighting device 5 comprises a light mixing element 50 provided within an envelope 52. The envelope 52 comprises a bulb 54. The bulb 54 is connected to a base 53. LEDs 51 are provided within the envelope 52 and arranged in the light mixing element 50. The LEDs 51 are arranged to emit light into the light mixing element 50. The components of FIGS. 5a and 5b can have the same structure and function as the corresponding ones in the first embodiment.

The LEDs 51 are arranged at the ends of the light mixing element 50 in order to be located as close to the bulb 54 of the envelope 52 as possible. It has been realized that an improvement in heat conduction over conventional incandescent lamps, and also over known LED lighting devices mimicking incandescent lamps, can be reached by placing the LEDs 51 close to the bulb 54. Heat produced by the LEDs 51 is thereby transported to the outside of the lighting device 5 by natural convection, indicated by 56, and also by direct heat conduction, indicated by 55, to the bulb 54 through the internal gas of the glass bulb 54.

If a distance d between an end of the light mixing element and the bulb 54 is sufficiently small, the direct heat conduction 55 may transfer heat more efficiently than the natural convection 56. It has been realized that this is achieved when the distance d is equal to or smaller than the summed effective thermal boundary layers at the light mixing element side and at the bulb side.

Between the light mixing element and inner bulb, wall flow and temperature fields are formed and the properties of the gas define the thickness of these boundary layers. This is related to the well known Grashof number of the gas. Comparing air and helium the velocity and thermal boundary layer in helium is in the order of three times that of air. This result in a thermal behavior in the region between bulb wall and tube-end that is different for the two gasses. In case of a more conduction dominated behavior, as is the case for helium, the distance end of light mixing element to wall becomes important. The relative thermal resistance of the end of the light mixing element and the bulb wall for helium and air is shown in table 1.

TABLE 1

| Distance end of | Relative thermal | Relative thermal |
|---|---|---|
| light mixing | resistance at end | resistance at end |
| element - bulb | of light mixing | of light mixing |
| wall [mm] | element for helium | element for air |
| 10.5 | 1.0 | 1.0 |
| 8 | 0.93 | 1.01 |
| 6.7 | 0.89 | 1.02 |
| 5.3 | 0.84 | 1.04 |
| 4.2 | 0.75 | 1.03 |

In case of helium a smaller distance leads to lower thermal resistance and below 7 mm the decrease is becoming steeper. This is the conduction region. However, in case of air, the opposite is seen, reducing the distance leads to an increase. That is for air the heat transport is more flow dominated.

The distance d may be kept small due to the use of the light mixing element 50 which may be provided in an elongated form. By use of the light mixing element 50, comprising a thermally conductive and translucent ceramic material, an advantage of that the heat dissipation area to the internal gas is increased is also achieved. This advantage is due to that heat from the LEDs 51 is conducted through the material of the light mixing element 50 and dissipated from its surface.

The lighting device according to the present invention thus provides improved heat dissipation efficiency. This is an improvement over conventional lighting devices, such as the one illustrated in FIG. 4. For example, for a lighting device comprising an LED arranged on a substrate and located in a bulb (without any light mixing element), the heat conduction to the internal gas of the glass bulb is limited by the surface area of the substrate. The LED is typically centrally located in such a lighting device, as also illustrated in FIG. 4, meaning that the LED is not located near the bulb. The heat is transported to the outside of the lighting device mainly by free convention from the LEDs and/or the LED substrate to the internal gas and secondly by free convection from gas to the bulb.

By a lighting device according to the present invention, the heat dissipation efficiency is improved by providing the LED close to the bulb so as to increase the direct heat conduction, and also by providing an increased surface area for heat dissipation in the form of the light mixing element comprising a thermally conductive and translucent ceramic material. The light mixing element acts as an improved heat spreader, which can be referred to as a type of cooling fin, due to its high thermal conductivity in comparison to materials such as plastics or acrylic.

The envelope may be filled with a low weight gas or a mixture comprising a low weight gas, such that the gas/gases is in thermal contact with the light mixing element and the bulb. Such gases improve the thermal properties and thus enhance the heat conduction from the light mixing element to the glass bulb. By low weight gas is meant a gas having a low weight and low viscosity in combination with a high thermal conductivity. Example of a low weight gases are hydrogen and helium. An example of a mixture comprising a low weight gas is a mixture between helium (being a low weight gas) and a dioxe gas (being a medium weight gas).

How small the distance d needs to be in order to achieve a significant direct heat conduction depends on the composition of the internal gas. As an example, it has been found that a distance d of 10 mm or less in combination with internal gas comprising at least 70% helium by volume provides the advantage of increased heat conduction efficiency.

The pressure of the gas within the envelope is preferably high. When using He as gas, a pressure above 10 mbar, preferably above 100 mbar, provides a good cooling of the light source and of the light mixing element.

Depending on the orientation of the light mixing element, the LED may be arranged at different positions. For example, in the first embodiment illustrated in FIG. 1, the one or more LEDs 11 are arranged at end positions in similar to the third embodiment illustrated in FIGS. 5a and 5b. In the second embodiment illustrated in FIG. 2, the one or more LEDs 21 are preferably placed at the top of the light mixing element 20, i.e. close to the wall of the bulb 24, in order to improve the heat conduction efficiency.

A lighting device 6 according to a fourth embodiment is illustrated in FIG. 6. The lighting device 6 comprises a light mixing element 60 according to any one of the other embodiment of the present invention. A LED (not illustrated) is arranged within the light mixing element 60. A support member in the form of a pair of conducting wires 61 are arranged within the envelope of the lighting device 6. The conductive wires 61 conductively connect the LED such that the LED may be powered when the lighting device 6 is attached to an external power supply. The conductive wires 61 also functions as a support to light mixing element 60. The conductive wires 61 are stiff in order to provide the supporting function. The pair of conductive wires 61 is not in optical contact with the light mixing element 60 in order to prevent optical failures.

Each of the conductive wires 61 comprises a spring element 62. The purpose of the spring element 62 is to provide a flexible portion of the support member. Assuming that the conductive wires 61 are made in a stiff material, the support member thus comprises a flexible portion and a stiff portion.

The spring element 62 may be in the form of an elastic portion of the wire such as a metal spring. The spring elements 62 are advantageous in that they can absorb vibrations of the light mixing chamber 60 so as to stabilize the light emission path.

The conductive wires 61 may be coated with an electrically isolating material. Thus, the conductive wires 61 are safe to touch if the glass bulb would break. The light mixing element 60 is difficult to break either since it is made in a ceramic material, preferably a PCA material.

In an alternative embodiment (not illustrated), the realization of a flexible portion and a stiff portion of the support member is provided by combining a flexible conductive wire, such as a bendable thin metal wire, and a stiff tube or the like which can be made of plastics or glass. The flexible conductive wire may be arranged within the stiff tube such that it is supported by the tube. The conductive wire is connected to the light sources and the light mixing element in the same manner as the conductive wire 61 disclosed above. The construction combining the flexible conductive wire with the stiff tube provides a stable positioning of the light mixing element, due to the stiff portion in the form of the stiff tube, while still permitting absorption of small movements due to the flexible portion in the form of the flexible conductive wire. The stiff tube may be attached to or formed as a portion of a stem tube of the lighting device.

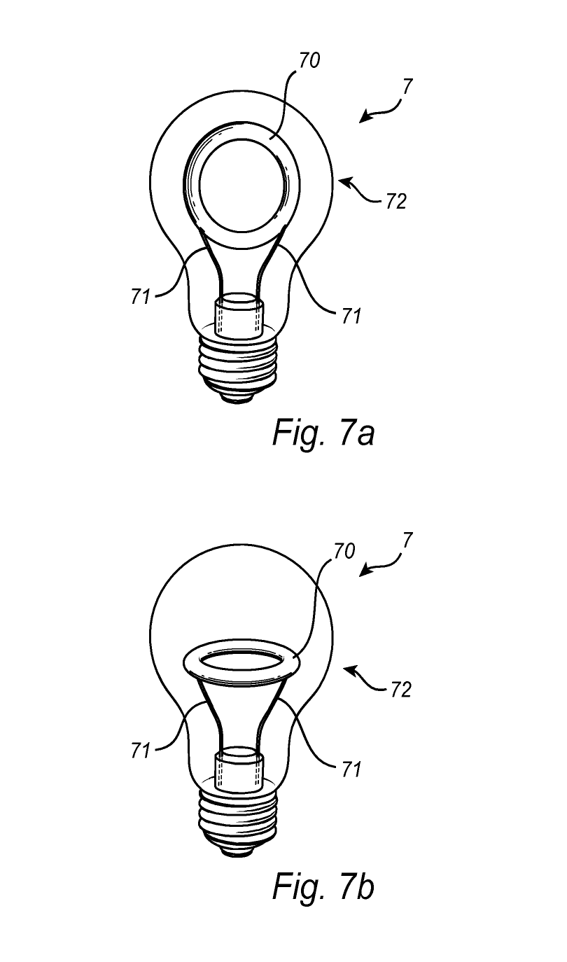

FIGS. 7a and 7b illustrate alternative embodiments of a lighting device 7. The lighting device 7 comprising a light mixing element 70 of a different shape when compared to earlier disclosed embodiments. The light mixing element 70 is formed by a closed tube. The tube may be hollow. The tube may have a circular or elliptical shape. The light mixing element 70 may be attached by means of support members 71 in accordance to any of the previous disclosed embodiments. Light sources in the form of LEDs (not illustrated) are preferably arranged within the light mixing element 70 at positions close to an envelope 72 of the lighting device 7.

The light mixing element 70 may be arranged with its center axis along an elongation axis of the lighting device 7 (FIG. 7b) or perpendicular to the elongation axis (FIG. 7a).

It is understood that the above disclosed embodiments may be combined or altered in any possible way. The person skilled in the art realizes that the present invention by no means is limited to the preferred embodiments described above. On the contrary, many modifications and variations are possible within the scope of the appended claims. For example, the main surfaces of the end caps 33 in FIG. 3 are flat in order to facilitate assemble of the LEDs 31. The main surfaces of the end caps 33 may alternatively be concavely shaped such that the shape of their outer surface follows the shape of the envelope. This design may provide a more appealing aesthetic look. As another example, the surface of the light mixing element can be provided with a structure to create special light effects. It is also noted that the term LED may refer to a diode unit alone or to a diode unit attached to a substrate such as a printed circuit board. The lighting device according to the present invention may be provided in a luminaire, i.e. a light fixture, for use in a wide range of applications such as for home use, hospitality use, outdoor use, use in office and industry, retail use or entertainment use.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A lighting device comprising:
a hollow and translucent envelope connected to a base;
a light mixing element arranged within the envelope; and
at least one light emitting diode arranged within the envelope, arranged to emit light into the light mixing element and arranged in thermal contact with the light mixing element;
wherein the light mixing element comprises a thermally conductive and translucent ceramic material;
wherein light emitted from the light emitting diode is mixed within the light mixing element, distributed from the light mixing element through the thermally conductive and translucent ceramic material, and transmitted through the translucent envelope,
wherein a distance between the light mixing element and the envelope is equal to or smaller than the summed effective thermal boundary layers at the light mixing element side and at the envelope side, such that the direct heat conduction transfers heat more efficiently than the natural convection.

2. The lighting device according to claim 1, wherein the thermally conductive and translucent ceramic material is poly crystalline alumina.

3. The lighting device according to claim 1, wherein the light mixing element has a cylindrical shape.

4. The lighting device according to claim 1, wherein the light mixing element forms a light mixing chamber.

5. The lighting device according to claim 1, wherein the light mixing element is hollow.

6. The lighting device according to claim 1, wherein a light emitting diode is arranged at an end of the light mixing element which faces the envelope.

7. The lighting device according to claim 1, wherein a light emitting diode is arranged in each end of the light mixing chamber which faces the envelope.

8. The lighting device according to claim 1, wherein the light mixing element comprises a cylindrical tube, wherein the light mixing element comprises an end cap at each end of the cylindrical tube, and wherein a light emitting diode is arranged within the cylindrical tube at each end cap.

9. The lighting device according to claim 1, wherein the envelope is filled with a gas comprising at least 70% helium by volume, and wherein the distance between the a light mixing element and the envelope is equal to or less than 10 mm.

10. The lighting device according to claim 1, further comprising a support member connecting the at least one light emitting diode to the base, wherein the support member is arranged to support the light mixing element.

11. The lighting device according to claim 10, wherein the support member comprises one or more spring elements.

12. The lighting device according to claim 10, wherein the support member is coated with an electrically isolating material.

13. The lighting device according to claim 1, wherein the envelope is filled with a low weight gas or a mixture comprising a low weight gas arranged in thermal contact with the at least one light emitting diode the light mixing element and the envelope.

14. A luminaire comprising a lighting device according to claim 1.
